(19) United States
(12) Patent Application Publication
(10) Pub. No.: US 2011/0113178 A1
(43) Pub. Date: May 12, 2011

(54) COMPUTER DEVICE AND CONTROL METHOD FOR THE SAME

(75) Inventors: Motooki HOSOI, Hadano (JP); Satoru UEMURA, Hadano (JP); Masao OGIHARA, Hadano (JP)

(73) Assignee: HITACHI, LTD., Tokyo (JP)

(21) Appl. No.: 12/939,295

(22) Filed: Nov. 4, 2010

(30) Foreign Application Priority Data
Nov. 9, 2009 (JP) 2009-256414

(51) Int. Cl. G06F 13/20; G06F 13/00

(52) U.S. Cl. 710/313; 710/300

(57) ABSTRACT

Relay buffers 600, 601, 602, and 603 in a computer module 110 and an I/O module 120 each have a noise filter circuit for determining the amplitude of a signal to/from PCIe interfaces 161 and 162 to distinguish a signal from noise and controlling ON/OFF of output signals. An I/O hub 300 and a PCIe switch 400 make a switch between enablement and disablement of the noise filter circuits in the relay buffers according to communication mode, and disables the noise filter circuits when communication is performed at a high rate. Cable removal detecting circuits 115 and 125 notify the I/O hub 300 and the PCIe switch 400 of a removal of a PCIe cable 151 to prevent a malfunction caused by noise that results from a PCI glitch.

### CLAIM OF PRIORITY

The present application claims priority from Japanese patent application JP 2009-256414 filed on Nov. 9, 2009, the content of which is hereby incorporated by reference into this application.

### BACKGROUND OF THE INVENTION

1. Field of the Invention

The present invention relates to a computer device having a PCI Express (PCIe) interface, and more particularly to a method and an apparatus for preventing a malfunction caused by noise in the PCI Express interface.

2. Background Art

Many conventional computer devices use Peripheral Component Interconnect Express (PCIe) as a connection interface with I/O devices (see PCI Express Base Specification 2.0 “1. Introduction”). According to the PCIe, the number of I/O devices that can be connected to a computer module can be increased by arranging switches internally. With Multi-Root I/O Virtualization (MR-IOV), which is an extension to the PCIe specification, multiple computer modules can share the same I/O devices via a PCIe switch supporting the MR-IOV (see Multi-Root I/O Virtualization and Sharing Specification Revision 1.0 “1.1 Architectural Overview”). Particularly to add I/O devices for a computer module which is structurally limited in the number of I/O ports that can be implemented, such as a blade server module, a device (an I/O module) on which multiple I/O devices can be mounted is provided separately from the computer module, and the I/O module is connected with the computer module through a cable in many cases.

While the conventional PCI Express Base Specification 1.0a defines an interface communication rate of 2.5 Gbps, PCI Express Base Specification 2.0 defines a higher communication rate at 5 Gbps in addition to 2.5 Gbps. However, since signal attenuation rate generally increases with a higher signal frequency due to skin effect in transmission of electrical signals that uses wires on printed circuit board or cables, there is a problem of limitation on transmission distance. Consequently, degradation in signal attenuation rate is more noticeable in 5-Gbps communication than in 2.5-Gbps communication.

A general way to address this problem is to include a relay buffer for waveform compensation, such as a re-driver and an equalizer, in the interface for extending the transmission distance and restore an attenuated signal waveform in the relay buffer, such as described in JP Patent Publication (Kokai) No. 2001-285312A, for instance.

One matter to keep in mind when using a waveform compensating device in the PCIe interface is that according to the PCIe interface specification which defines power-saved operations, there can be a state where the potential difference between the P-pole and the N-pole of a differential signal becomes 0 V, which is called Electrical Idle (EI), in power-saved operations during which communication is not performed, in addition to normal operations during signal transmission.

However, since the differential signal actually is not exactly 0 V even in the EI state due to noise in parts or the like of the device even though a logical no-signal state is defined as having a potential difference of 0 V, the PCIe interface specification defines a noise threshold (a maximum of 175 mV, PCI Express Base Specification 2.0, Section 4.3.4.4).

A condition for a device stipulated is defined by the PCIe interface specification that the length of a signal wire is 28 inches or shorter on a general printed circuit board using FR4 material (PCI Express Base Specification 2.0, Section 4.3.4.3) which is generally used.

Unlike printed circuit board, cable allows a wide range of combination of wire materials used and transmission schemes (e.g., transmission by electrical signals or optical transmission using fibers), and attenuation rate on a cable per unit length varies depending on cable type. Thus, the PCIe interface specification prescribes a total attenuation of 12 dB or smaller for a cable, rater than merely based on cable length (PCI EXPRESS EXTERNAL CABLING SPECIFICATION REV 1.0, Section 6.2.2.1).

A relay buffer inserted in the PCIe interface identifies an EI state according to the amplitude of an input signal, and filters out signals equal to or below a predetermined threshold as noise.

When the wire length exceeds the one defined in the PCIe interface specification mentioned above due to limitation on device implementation or the like, however, an input signal to the PCIe interface to be supplied to the relay buffer can significantly attenuate and drop below the threshold set in the relay buffer.

When the relay buffer does not perform amplitude-based filtering and amplifies all inputs from an upstream side, signals corresponding to normal operation of the PCIe interface cannot be distinguished from noise, and the relay buffer amplifies even noise to possibly cause output of irregular pattern signals.

Although generation of a random pattern signal caused by noise amplification can be prevented by setting a smaller threshold than the one defined by the PCIe interface specification in the relay buffer, commercially available relay buffers then cannot be used because commercial relay buffers typically have the threshold of the PCIe interface specification set therein. This has serious disadvantages in terms of cost, such as increase in part development cost and part purchase price. Even if the threshold level of the relay buffer is decreased, noise caused in the EI state may not be distinguished from a normal signal depending on variation in LSI manufacturing, and output may be interrupted during normal transmission.

Another cause of a random pattern signal is noise caused by a glitch which occurs when a cable is removed while the relay buffer is in operation without performing a disconnection process for the PCIe interface. In operation of a device to which cables are connected, erroneous removal of a cable due to a misoperation by an operator occurs more frequently than failures of device components or the cable itself and can occur regardless of communication status of the PCIe interface, such as normal operation and the EI state. When filtering based on input signal amplitude is implemented, generation of a random pattern signal produced by noise resulting from a glitch can be prevented, but noise cannot be distinguished from an attenuated normal signal just as noise in the EI state described above.

When a random pattern signal is received by an LSI, its internal logic may cause an unexpected operation in response to input of a signal that is not defined in the PCIe interface specification. In conventional single-route connection, when a malfunction has occurred in an I/O device, the failure affects only within a PCI tree that is constituted of PCI devices connected with a computer module. On the other hand, in a multi-route connection in which multiple computer modules share I/O devices via switches, effect of a malfunction can propagate via a PCIe switch to individual PCIe trees connected and halt the entire system.

An object of the present invention is therefore to provide a computer device and a PCI-Express interface control method that can properly identify noise and prevent a misoperation even in a case where a relay buffer for a PCIe interface is applied on a wireline on which a signal attenuates more than defined in the PCIe interface specification and attenuation of an input signal can be so significant depending on operation mode that a signal for communication through the PCIe interface cannot be distinguished from noise.

The above and other objects as well as novel features of the present invention will become apparent from the description herein and the accompanying drawings.

### SUMMARY OF THE INVENTION

A computer device according to the present invention connects a computer module with an I/O module through a PCIe interface, and comprises relay buffers for signal waveform compensation. The relay buffers in each of the computer module and the I/O module make a switch between enablement and disablement of noise filter circuits according to the operation mode of a PCIe interface signal, thereby distinguishing an attenuated signal from noise and preventing generation of a random pattern signal caused by noise.

The computer device also detects the connection state of a cable to prevent generation of a random pattern signal caused by noise arising from a glitch that occurs when the cable is mistakenly removed.

According to the invention, in a computer device in which multiple computer modules and I/O modules are interconnected by PCIe interfaces via PCIe switches and multiple routes constitute PCIe trees, operation can be continued by the PCI Express switches preventing propagation of effect of a malfunction associated with a random pattern signal to PCIe trees.

### BRIEF DESCRIPTION OF THE DRAWINGS

FIG. 1 is a block diagram showing an exemplary configuration of a computer device according to an embodiment of the present invention.

FIG. 2 is a block diagram showing connection between a computer module and an I/O module.

FIG. 3 is a block diagram showing an exemplary configuration of a relay buffer.

FIG. 4 is a block diagram showing an exemplary configuration of an I/O hub.

FIG. 5 is a block diagram showing an exemplary configuration of a PCIe switch.

FIG. 6A is a flowchart illustrating operation of a PCIe interface implemented by the computer device during 2.5-Gbps and 5-Gbps communication.

FIG. 6B is a flowchart illustrating operation of a PCIe interface implemented by the computer device during 2.5-Gbps and 5-Gbps communication.

FIG. 7 is a flowchart illustrating operation of a PCIe interface implemented by the computer device in an EI state.

FIG. 8 is a flowchart illustrating a process of detecting a cable removal by the PCIe interface implemented by the computer device.

FIG. 9 is a state transition diagram illustrating state transition of the PCIe interface implemented by the computer device.

### DESCRIPTION OF SYMBOLS

100 computer device

110 to 112 computer module

120, 121 I/O module

115, 125 cable removal detecting circuit

151, 152 PCIe cable

161, 162 PCIe interface

165, 166 GND signal

200 CPU

300 I/O HUB

400, 401 PCIe switch

310, 710 protocol conversion unit

410 to 413 PCIe port

320, 620, 720 output buffer

330, 610, 611, 730 input buffer

340, 440 parallel-to-serial conversion unit

350, 450 serial-to-parallel conversion unit

360, 760 EI generating unit

370, 770 received-data switch

380, 780 communication mode status register

390, 790 communication mode capability register

500 to 502 PCIe device

600 to 603 relay buffer

605 noise filter circuit

630 reference voltage generating circuit

640 comparator circuit

650, 651 noise-filter-circuit control signal

660, 661 cable removal detection signal

### DETAILED DESCRIPTION OF THE PREFERRED EMBODIMENTS

An embodiment of the present invention will be described in detail with reference to drawings.

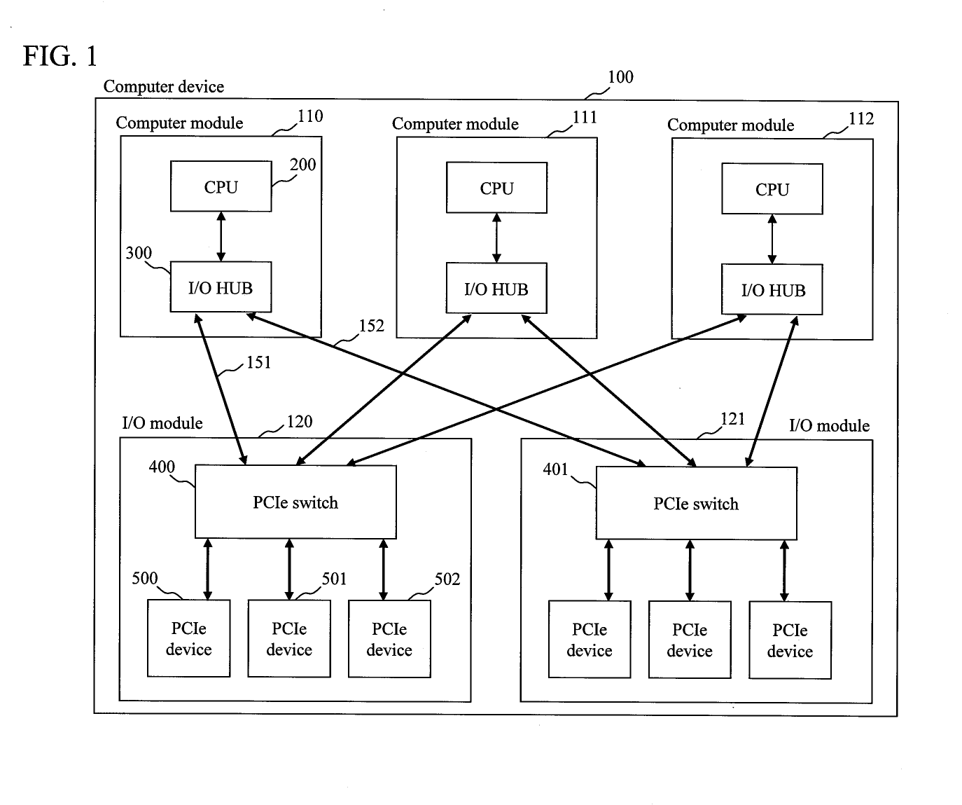

FIG. 1 is a block diagram showing an exemplary configuration of a computer device according to an embodiment of the invention.

A computer device 100 includes one or more computer modules 110, 111, 112, and one or more I/O modules 120, 121. The computer module 110 has a CPU (a processor) 200 and an I/O hub 300 which are connected with each other through a system bus. The I/O module 120 has a PCIe switch 400 and one or more PCIe devices 500, 501, and 502. The I/O hub 300 in the computer module 110 can communicate with PCIe switches 400 and 401 in the I/O modules 120 and 121 via PCIe cables 151 and 152, respectively.

The computer modules 110 to 112 have memory 210 to store an Operating System (OS) and application programs to be executed by the CPU 200.

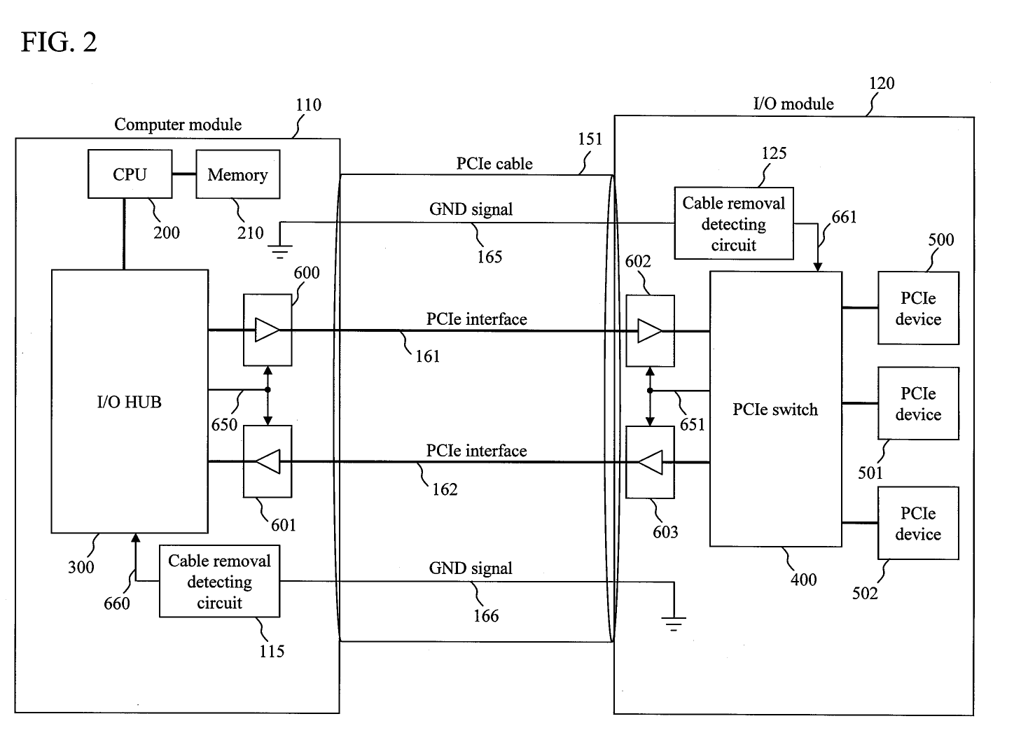

Now, an exemplary configuration of a PCIe interface for the computer device according to the embodiment of the invention will be described using FIGS. 2 to 5. FIG. 2 shows a configuration of PCIe interfaces between a computer module and an I/O module in the computer device according to the embodiment of the invention.

In FIG. 2, a relay buffer 600 in the computer module 110 amplifies an output signal from the I/O hub 300 and outputs the amplified signal to a PCIe interface 161. A relay buffer 602 in the I/O module 120 amplifies a signal from the PCIe interface 161 and outputs the amplified signal to the PCIe switch 400. Similarly, a relay buffer 603 amplifies an output signal from the PCIe switch 400 and outputs the amplified signal to a PCIe interface 162. The relay buffer 601 amplifies a signal from the PCIe interface 162 and outputs the amplified signal to the I/O hub 300.

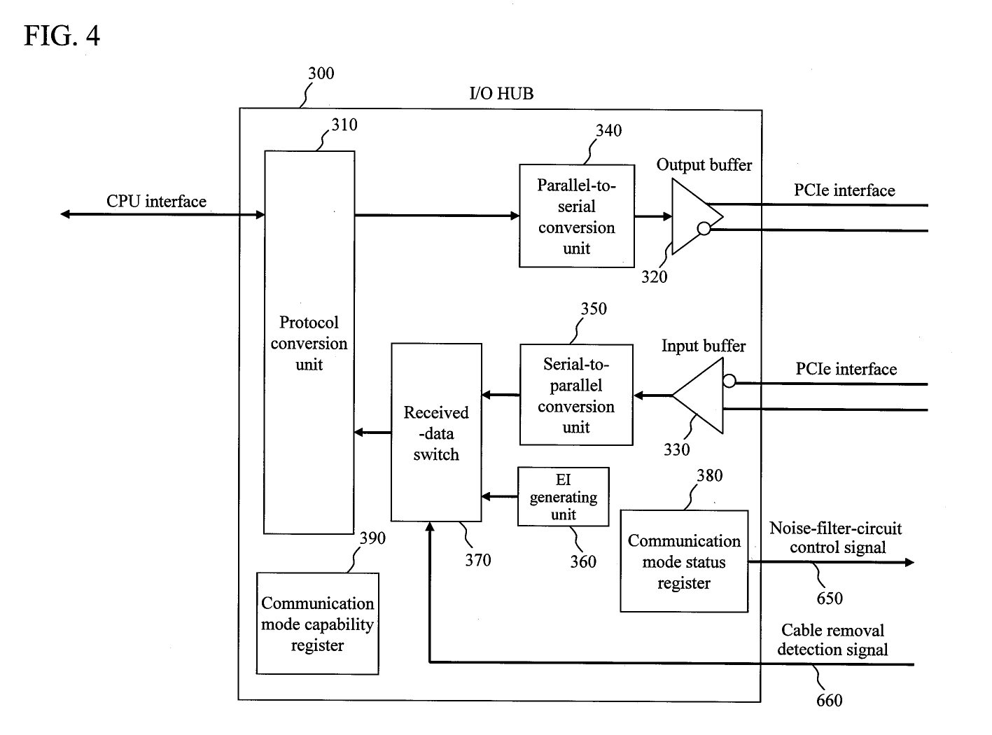

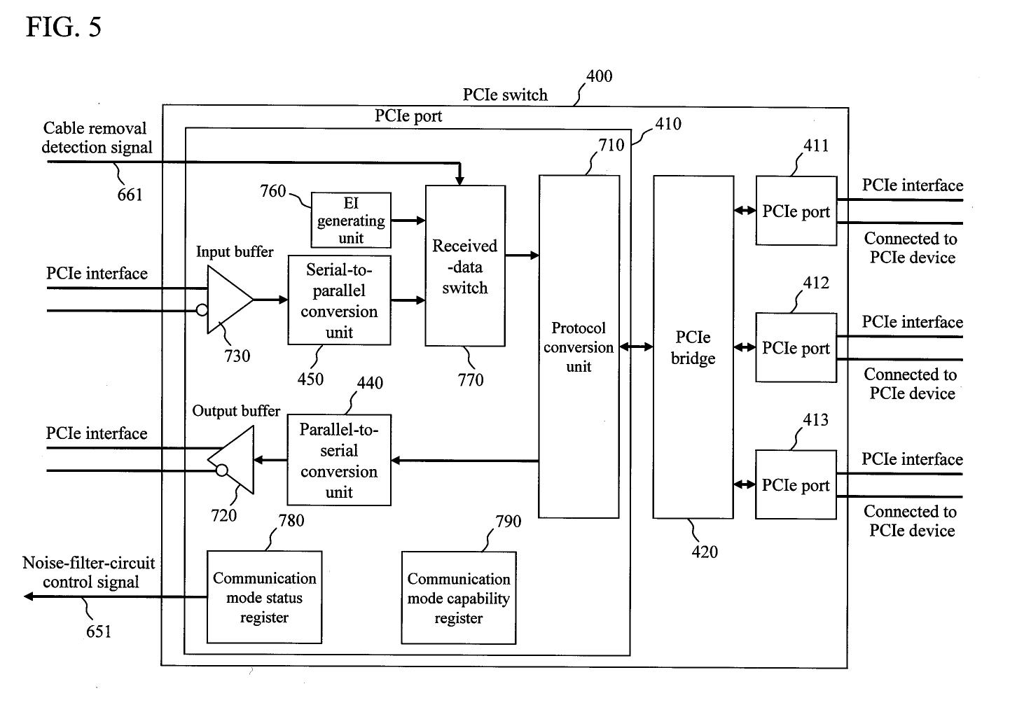

Cable removal detecting circuits 115 and 125 are respectively coupled with GND signals 165 and 166 in a PCIe cable 151 and grounded in the devices to which they are connected. When the PCIe cable 151 is removed, the cable removal detecting circuits 115 and 125 detect a change in potential and notify the I/O hub 300 and the PCIe switch 400 of the change, respectively. Upon input of cable removal detection signals 660 and 661, the I/O hub 300 and the PCIe switch 400 stop serial-to-parallel conversion of signals received by the input buffers 330 and 730 (see FIGS. 4 and 5) to prevent glitch propagation to a protocol conversion unit.

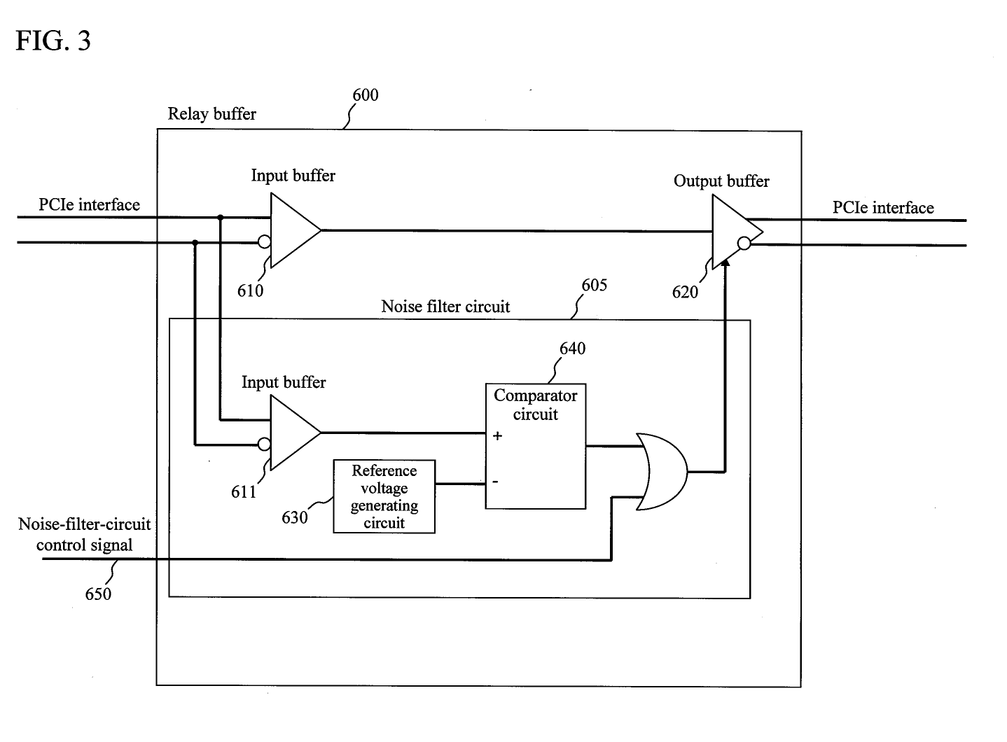

FIG. 3 shows an exemplary configuration of a relay buffer included in computer modules and I/O modules. The exemplary configuration is described taking the relay buffer 600 included in the computer module 110 as an example. The relay buffer 600 has therein an input buffer 610, an output buffer 620, and a noise filter circuit 605. The noise filter circuit 605 includes an input buffer 611, a reference voltage generating circuit 630, and a comparator circuit 640. A PCIe input signal is output by way of the input buffer 610 having equalizer capability and the output buffer 620 having pre-emphasis capability. Also, the output amplitude of the input buffer 611 is compared with output of the reference voltage generating circuit 630 in the comparator circuit 640. When the output amplitude is equal to or below that of the PCIe interface specification, the signal is identified as noise and output of the output buffer 620 is stopped.

The relay buffers 600 and 601 also receive a noise-filter-circuit control signal 650 from the 110 hub 300. Similarly, the relay buffers 602 and 603 receive a noise-filter-circuit control signal 651 from the PCIe switch 400. The 110 hub 300 and the PCIe switch 400 switch the noise-filter-circuit control signal 650 according to the communication mode of the PCIe interface, enabling or disabling the comparator circuit 640.

When the communication mode of the PCIe interface is 2.5 Gbps operation or the EI state, output of the output buffer 620 is enabled or disabled according to a result from the comparator circuit 640. During 5-Gbps operation, output of the output buffer 620 is enabled regardless of the result from the comparator circuit 640. That is, the function of the noise filter circuit 605 is disabled at the time of 5-Gbps operation.

FIG. 4 shows an exemplary configuration of the 110 hub 300 included in the computer module 110. The 110 hub 300 includes a protocol conversion unit 310, a parallel-to-serial conversion unit 340, a serial-to-parallel conversion unit 350, an output buffer 320, an input buffer 330, an EI generating unit 360, a received-data switch 370, a communication mode status register 380, and a communication mode capability register 390. The protocol conversion unit 310 converts a transaction from the CPU 200 into a parallel signal according to the PCIe specification, and converts a response from a PCIe device to a transaction for the CPU 200. The parallel-to-serial conversion unit 340 converts the parallel signal after conversion by the protocol conversion unit 310 into a serial signal according to the PCIe specification, and outputs the signal from the output buffer 320. The serial-to-parallel conversion unit 350 converts a serial signal received by the input buffer 330 into a parallel signal and supplies the signal to the protocol conversion unit 310. The communication mode capability register 390 records whether functions defined in the PCIe specification are present or not, and records that the I/O hub 300 is capable of communication at 5 Gbps. The communication mode status register 380 stores the communication state of the I/O hub 300, and records presence/absence of a link to the PCIe interface and communication mode (i.e., 2.5 Gbps, 5 Gbps, or EI state).

FIG. 5 shows an exemplary configuration of the PCIe switch included in the I/O module 120. The PCIe switch 400 has PCIe ports 410, 411, 412, 413, and a PCIe bridge 420. The PCIe port 410 includes a parallel-to-serial conversion unit 440, a serial-to-parallel conversion unit 450, an output buffer 720, an input buffer 730, an EI generating unit 760, a received-data switch 770, a protocol conversion unit 710, a communication mode status register 780, and a communication mode capability register 790. The serial-to-parallel conversion unit 450 converts a serial signal received by the input buffer 730 from the I/O hub 300 into a parallel signal, and supplies the signal to the protocol conversion unit 710. The parallel-to-serial conversion unit 440 converts a parallel signal from the protocol conversion unit 710 into a serial signal, and outputs the signal from the output buffer 720. The communication mode capability register 790 stores whether functions defined in the PCIe specification are present or not, and records that the PCIe switch 400 is capable of communication at 5 Gbps. The communication mode status register 780 stores the communication state of the PCIe switch 400, and records presence/absence of a link to the PCIe interface and communication mode (i.e., 2.5 Gbps, 5 Gbps, or EI state). The PCIe bridge 420 switches connection of the PCIe ports 410, 411, 412 and 413.

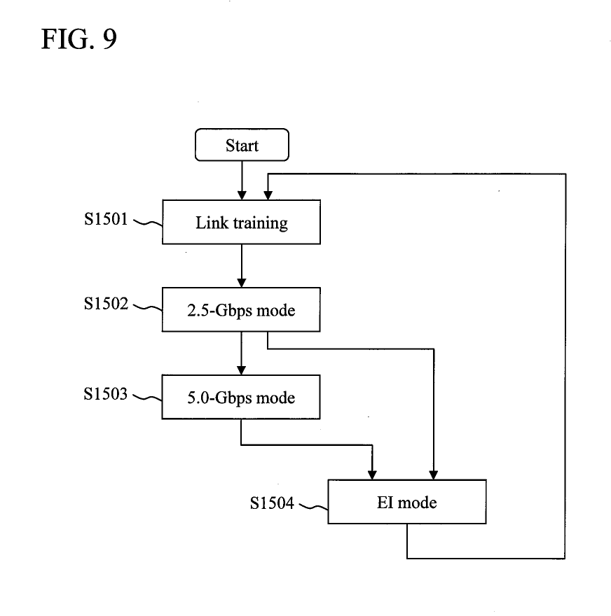

Now, state transition of the PCIe interface will be described with FIG. 9.

According to PCIe, link training is performed first between devices to be connected (step 1501). When both devices detect the other device to which they connect, a link is established therebetween in 2.5-Gbps mode. At this point, communication is performed at 2.5 Gbps between the devices (step 1502). If both the connected devices are capable of communicating at 5 Gbps, they transition to 5-Gbps mode. In this mode, communication is performed at 5 Gbps between the devices (step 1503).

When data transfer has not taken place for a certain time period between the connected devices in 2.5-Gbps and 5-Gbps modes, the devices transition to EI mode (step 1504). When it is necessary to transfer data between the connected devices in the EI mode, link training is performed again.

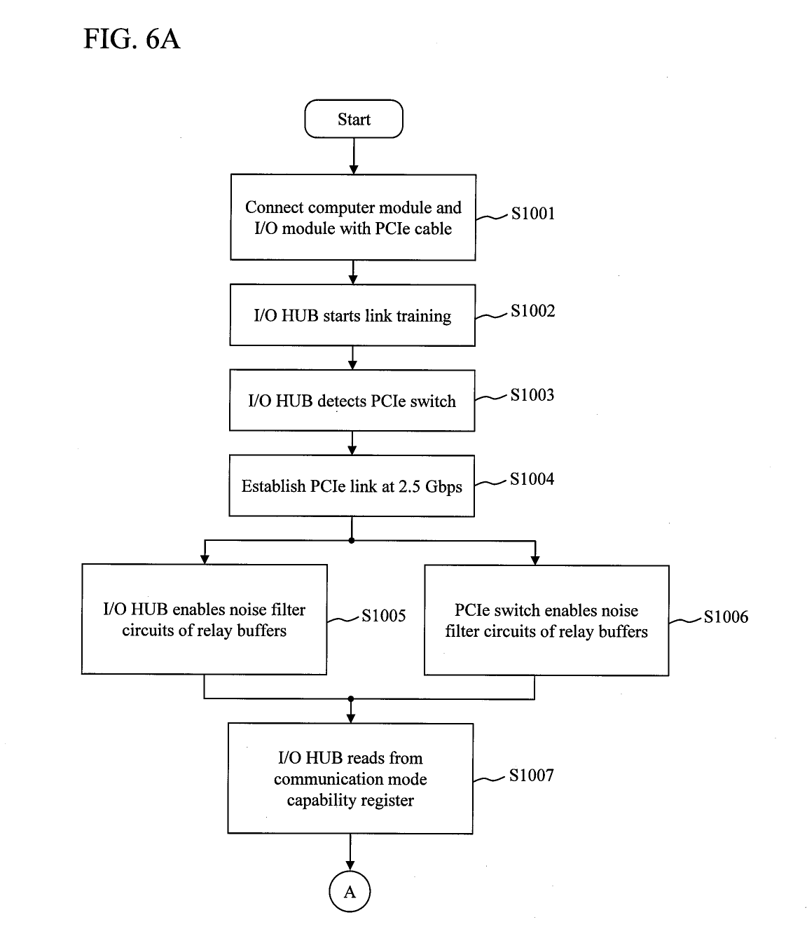

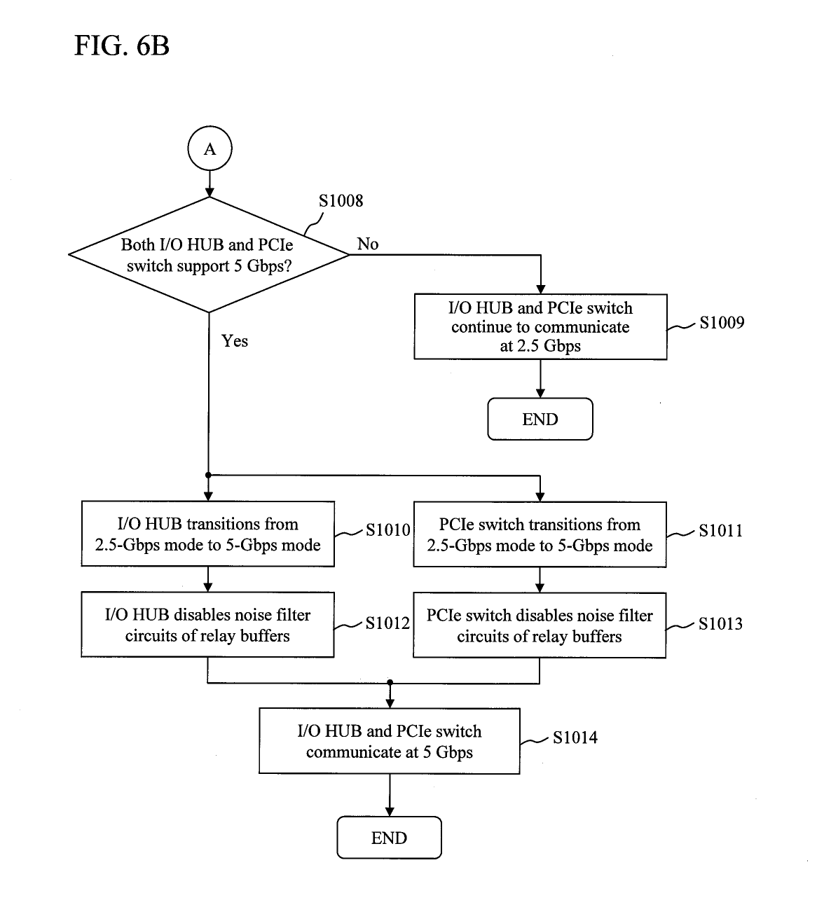

Now, operation of the computer device according to the embodiment of the invention in normal times will be described with FIGS. 2 to 5, 6A, and 6B.

First, the computer module 110 is connected with the I/O module 120 through the PCIe cable 151 (step 1001). The I/O hub 300 and the PCIe switch 400 start connection training (step 1002). The I/O hub 300 detects the PCIe switch 400 on the downstream side (step 1003).

The I/O hub 300 establishes a link with the PCIe switch 400 at 2.5 Gbps. The I/O hub 300 records in the communication mode status register 380 that the current mode is 2.5-Gbps mode. The PCIe switch 400 records in the communication status register 780 that the current mode is 2.5-Gbps mode (step 1004).

In 2.5-Gbps mode, the I/O hub 300 enables the respective noise filter circuits 605 in the relay buffers 600 and 601 via the noise-filter-circuit control signal 650 (step 1005). Similarly, the PCIe switch 400 enables the noise filter circuits 605 in the relay buffers 602 and 603 (step 1006).

The I/O hub 300 reads the contents of its own communication mode capability register 390 and the communication mode capability register 790 of the PCIe switch 400 via the PCIe interface (step 1007). The I/O hub 300 then determines whether both the I/O hub 300 itself and the PCIe switch 400 are able to operate at 5 Gbps from the contents of the communication mode capability registers 390 and 790 (step 1008).

If both or one of the I/O hub 300 and the PCIe switch 400 is unable to operate at 5 Gbps, the I/O hub 300 and the PCIe switch 400 continue to communicate in 2.5 Gbps mode (1009).

If both the I/O hub 300 and the PCIe switch 400 are able to operate at 5 Gbps, the I/O hub 300 and the PCIe switch 400 transition from the 2.5-Gbps mode to 5 Gbps (steps 1010 and 1011).

Since signal amplitude attenuates significantly and drops below the noise threshold of the PCIe specification during 5-Gbps communication, the I/O hub 300 disables the comparator circuit 640 in the respective noise filter circuits 605 of the relay buffers 600 and 601 via the noise-filter-circuit control signal 650. Similarly, the PCIe switch 400 disables the comparator circuit 640 in the respective noise filter circuits 605 of the relay buffers 602 and 603 via the noise-filter-circuit control signal 651 (steps 1012 and 1013). The I/O hub 300 and the PCIe switch 400 then continue to communicate in 5-Gbps mode (1014).

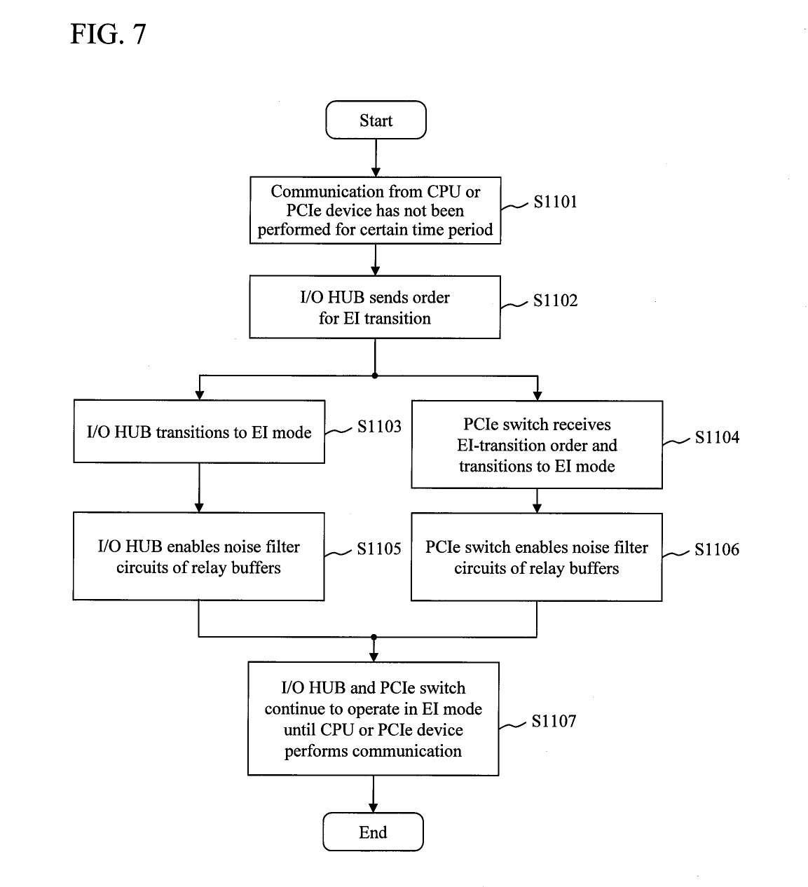

Now, operations of the computer device according to the embodiment of the invention at the time of transition to the EI mode will be described with FIGS. 2 to 5, and 7.

The I/O hub 300 and the PCIe switch 400 transition from 2.5-Gbps or 5-Gbps mode to the EI mode for power saving when there has been no communication from the CPU 200 or the PCIe devices 500, 501, and 502 for a certain time period. When transitioning to the EI mode, the I/O hub 300 sends an order for EI transition to the PCIe switch 400 via the PCIe interface 161 (steps 1101, 1102).

After issuing the EI transition order, the I/O hub 300 transitions to the EI mode. At the same time, the I/O hub 300 records that it is currently in EI mode in the communication mode status register 380 (step 1103). Upon receiving the EI transition order, the PCIe switch 400 transitions from 2.5-Gbps or 5-Gbps mode to the EI mode. At the same time, the PCIe switch 400 records that it is currently in EI mode in the communication mode status register 780 (1104).

In the EI mode, which has no transaction, all signals that are equal to or below the threshold defined in the PCIe specification are noise, so the I/O hub 300 enables the noise filter circuit 605 of the relay buffers 600 and 601 via the noise-filter-circuit control signal 650 (step 1105). Similarly, the PCIe switch 400 enables the noise filter circuit 605 of the relay buffers 602 and 603 via the noise-filter-circuit control signal 651 (step 1106).

The I/O hub 300 and the PCIe switch 400 then continue to operate in the EI mode until the next time communication is performed from the CPU 200 or the PCIe devices 500, 501, and 502 (step 1107).

In the above-described manner, enablement/disablement of the noise filter circuits for the input signal to the relay buffers is controlled according to the operational state of the PCIe interface so that an attenuated signal in 5-Gbps mode can be distinguished from noise in 2.5-Gbps mode or EI mode and the relay buffers can distinguish a signal equal to or below the threshold of the PCIe specification from noise. Even if noise is received, the relay buffers can prevent a malfunction associated with a random pattern signal resulting from noise by stopping their output.

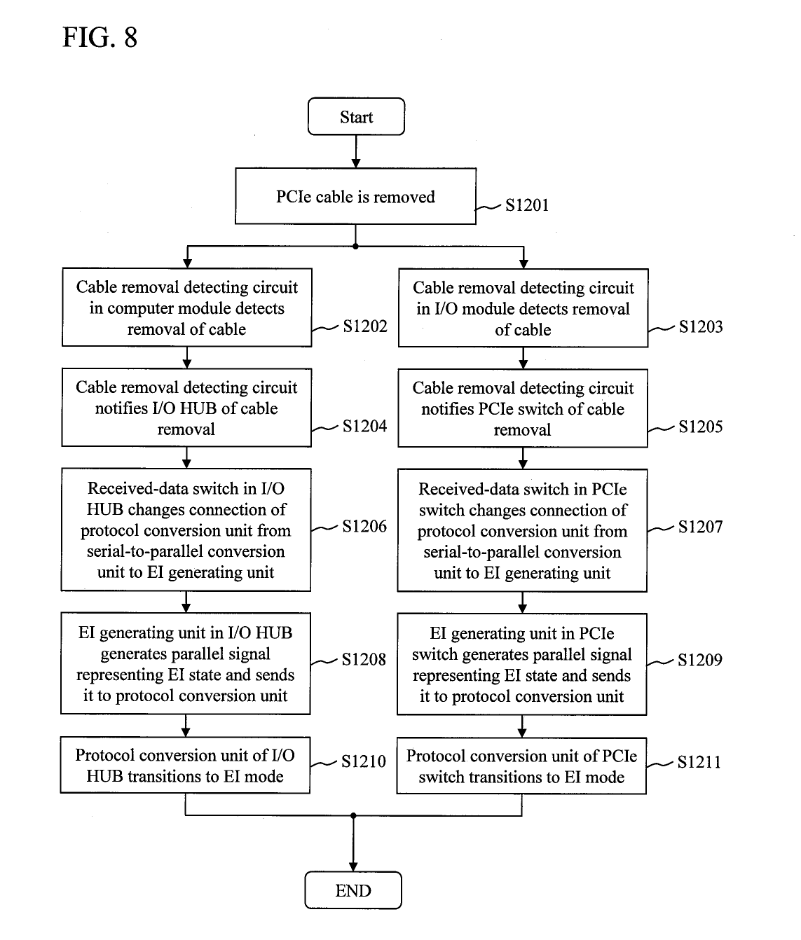

In the following, operations of the computer device according to the embodiment of the invention at the time of PCIe cable mistaken removal will be described with FIGS. 2, 4, 5, and 8.

Assume that the PCIe cable 151 on the PCIe link between the I/O hub 300 and the PCIe switch 400 is removed. In response, a random pattern signal caused by noise resulting from a glitch associated with the removal of the cable is generated (step 1201).

The cable removal detecting circuit 115 of the computer module 110 detects the removal of the PCIe cable 151 from a change in electrical potential of GND signal 166 that occurs when the PCIe cable 151 is removed (step 1202). Similarly, the cable removal detecting circuit 125 of the I/O module 120 also detects that the PCIe cable 151 has been removed from a change in potential of the GND signal 165 that occurs when the PCIe cable 151 is removed (step 1203).

The cable removal detecting circuit 115 of the computer module 110 notifies the I/O hub 300 of the cable removal via the cable removal detection signal 660 (step 1204). Similarly, the cable removal detecting circuit 125 of the I/O module 120 notifies the PCIe switch 400 of the cable removal via the cable removal detection signal 661 (step 1205).

Upon being notified of the cable removal, the received-data switch 370 of the I/O hub 300 changes connection of the protocol conversion unit 310 from the serial-to-parallel conversion unit 350 to the EI generating unit 360 (step 1206). Similarly, upon being notified of the cable removal, the received-data switch 770 of the PCIe switch 400 changes connection of the protocol conversion unit 710 from the serial-to-parallel conversion unit 450 to the EI generating unit 760 (step 1207).

The EI generating unit 360 of the I/O hub 300 generates data for a parallel signal representing EI state and sends the data to the protocol conversion unit 310 (step 1208). Similarly, the EI generating unit 760 of the PCIe switch 400 generates a parallel signal representing EI state and sends the signal to the protocol conversion unit 710 (step 1209).

Having received the parallel signal representing the EI state from the EI generating unit 360, the protocol conversion unit 310 of the I/O hub 300 transitions to the EI mode (step 1210). Similarly, having received the parallel signal representing the EI state from the EI generating unit 760, the protocol conversion unit 710 of the PCIe switch 400 transitions to the EI mode (step 1211).

As described above, a malfunction due to a random pattern signal caused by noise that results from a glitch can be prevented by monitoring cable connection state, generating a parallel signal representing the EI state when removal of a cable has been detected, and making the protocol conversion units transition to the EI mode.

Because the cable removal detecting circuit 115 of the computer module 110 monitors only a change in potential of the GND signal 166, overhead from detection of a cable removal to notification can be considered to be sufficiently shorter than overhead taken for noise filtering in the relay buffer 601 and overhead taken for serial-to-parallel conversion in the serial-to-parallel conversion unit 350 of the I/O hub 300. However, for ensuring the order of the operations, a wait can be inserted into the serial-to-parallel conversion.

Likewise, because the cable removal detecting circuit 125 of the I/O module 120 monitors only a change in potential of the GND signal 165, overhead from detection of a cable removal to notification can be considered to be sufficiently shorter than overhead taken for noise filtering in the relay buffer 602 and overhead taken for serial-to-parallel conversion in the serial-to-parallel conversion unit 450 of the PCIe switch 400. However, for ensuring the order of the operations, a wait can be inserted into the serial-to-parallel conversion.

Also, the present embodiment allows continuous operation by having the EI generating unit generate data representing the EI state upon removal of a cable to produce an EI state. As another form of implementation, operation can be continued by generating data for hot removal of a PCIe device instead of EI-representing data so as to make the OS perform a hot-removal process to make it seem that a PCIe device has been removed.

As described above, according to the present embodiment, a computer module and an I/O module are connected with each other via a PCIe interface and have relay buffers for signal waveform compensation. The relay buffers in the computer module and the I/O module make a switch between enablement and disablement of the noise filter circuits according to the operation mode of a PCIe interface signal, thereby enabling an attenuated signal to be distinguished from noise and preventing generation of a random pattern signal caused by noise.

In addition, by detecting the cable connection state, it is possible to prevent generation of a random pattern signal caused by noise resulting from a glitch that occurs when a cable is mistakenly removed.

Consequently, in a computer device in which multiple computer modules and I/O modules are interconnected by PCIe interfaces via PCIe switches and multiple routes constitute PCIe trees, operation can be continued by the PCI Express switches preventing propagation of effect of a malfunction caused by a random pattern signal to PCIe trees.

The present invention concerns a computer device having a PCIe interface and can be widely applied to devices that involve long-distance transmission of PCIe signals.

What is claimed is:

1. A computer device comprising:
a computer module which includes a processor and an I/O hub;
an I/O module which includes a PCIe switch and an I/O device; and
a cable that connects the computer module with the I/O module, wherein the I/O hub and the PCIe switch are connected with each other by a PCIe interface on the cable,
the computer module and the I/O module each comprise relay buffers for waveform compensation of a signal to/from the PCIe interface,
the relay buffers have filtering capability to filter out as noise a signal to/from the PCIe interface that has a signal amplitude equal to or below a threshold value, and
the I/O hub and the PCIe switch identify a communication mode of the PCIe interface and enable or disable the filtering capability of their respective relay buffers according to the communication mode.

2. The computer device according to claim 1, wherein
the I/O hub and the PCIe switch determine whether the communication mode of the PCIe interface is a communication mode with a first communication speed, a communication mode with a second communication speed higher than the first communication speed, or an EI state, and when in the first communication mode or the EI mode, enable the filtering capability of their respective relay buffers, and when in the second communication mode, disable the filtering capability of their respective relay buffers.

3. The computer device according to claim 1, wherein
the computer module and the I/O module each have a cable removal detecting circuit that monitors a connection state of the PCIe cable,
the cable removal detecting circuit notifies the I/O hub and the PCIe switch of a cable removal upon detecting a removal of the PCIe cable, and
the I/O hub and the PCIe switch stop reception from the PCIe interface upon being notified of the cable removal by the cable removal detecting circuit.

4. The computer device according to claim 3, wherein
the I/O hub and the PCIe switch replace a signal of the PCIe interface with a signal representing an EI state upon being notified of the cable removal by the cable removal detecting circuit.

5. A control method for a computer device that comprises a computer module which includes a processor and an I/O hub, an I/O module which includes a PCIe switch and an I/O device, and a cable that connects the computer module with the I/O module, wherein the I/O hub and the PCIe switch are connected with each other by a PCIe interface on the cable, and the computer module and the I/O module each comprise relay buffers for waveform compensation of a signal to/from the PCIe interface, and wherein
the relay buffers have filtering capability to compare an amplitude of a signal to/from the PCIe interface with a threshold value and filter out a signal having a signal amplitude equal to or below the threshold value as noise,
the method comprising the steps of:
identifying, by the computer module and the I/O module, a communication mode of the PCIe interface; and
enabling or disabling, by the I/O hub and the PCIe switch, the filtering capability of their respective relay buffers according to the communication mode.

6. The control method for a computer device according to claim 5, wherein
the step of identifying the communication mode of the PCIe interface determines whether the communication mode is a communication mode with a first communication speed, a communication mode with a second communication speed higher than the first communication speed, or an EI state; and
the step of enabling or disabling the filtering capability of the relay buffers according to the communication mode enables the filtering capability of the respective relay buffers when in the first communication mode or the EI state, and disables the filtering capability of the respective relay buffers when in the second communication mode.

7. The control method for a computer device according to claim 5, further comprising the steps of:
monitoring, by the computer module and the I/O module, a connection state of the PCIe cable;
notifying the I/O hub and the PCIe switch of a cable removal upon detecting a removal of the PCIe cable; and
stopping, by the I/O hub and the PCIe switch, reception from the PCIe interface when I/O hub and the PCIe switch have been notified of the cable removal.

8. The control method for a computer device according to claim 7, wherein the I/O hub and the PCIe switch replace a signal of the PCIe interface with a signal representing an EI state upon being notified of the cable removal.
